(19) United States
(12) Patent Application Publication
(10) Pub. No.: US 2007/0067623 A1
(43) Pub. Date: Mar. 22, 2007

(54) Detection of system compromise by correlation of information objects

(75) Inventor: Jean Renard Ward, Arlington, MA (US)

Correspondence Address: LAW OFFICE OF DAVID H. JUDSON, 15950 DALLAS PARKWAY, SUITE 225, DALLAS, TX, 75248, US

(73) Assignee: Reflex Security, Inc.

(21) Appl. No.: 11/524,558

(22) Filed: Sep. 21, 2006

Related U.S. Application Data
(60) Provisional application No. 60/719,676, filed on Sep. 22, 2005.

(51) Int. Cl. H04L 9/00

(52) U.S. Cl. 713/164

(57) ABSTRACT

The present invention describes a class of techniques for discovering evidence that a computer system has been compromised or attacked successfully. In an illustrative embodiment, a detection method involves detecting discrepancies between what a (compromised) operating system reports about enumerations of system objects, and the specific instances of those objects found by other (instrumentation) software running on the same system. In an alternative, the method detects discrepancies in the properties of a system object as reported by the operating system, and the properties as determined by other (instrumentation) software. In an alternative, the method detects discrepancies in invariant properties among a number of system objects. Preferably, the discrepancies are detected in real-time.

### CROSS-REFERENCE TO RELATED APPLICATION

This application is based on and claims priority from provisional application Ser. No. 60/719,676, filed Sep. 22, 2005.

### BACKGROUND OF THE INVENTION

1. Technical Field

The present invention relates generally to computer system security.

2. Background of the Related Art

As has become well-known in the field of computer security, no system can be guaranteed to be protected from compromise completely. In particular, those computer systems that provide access to, or that make access to services through some communications mechanism (e.g., the Internet, email, removable disk, USB driver port, or otherwise), are subject to attack and compromise. A defect or bug in the system (or security weakness) can be exploited to inject a payload of unauthorized code (sometimes referred to as “shell code”) that will then execute on the compromised system.

Thus, providing a means to detect that an attack payload is operating on a computer system often is vital to system security, because it is typically impossible to protect a system against all possible attack payloads. One such payload would be the installation of a kernel rootkit, which runs unauthorized code in threads or processes within the kernel of the operating system. Another exemplary class would be the injection of a dynamic link library (DLL) or other code-containing module into process memory of an existing process or thread. The injected code would then execute in the context and privilege of that existing service or program on the system. A further exemplary class would be a small payload that starts running an instance of an existing program on the system in an unauthorized manner, such as starting a local Web browser program to connect to a particular web site (which would then trigger unauthorized data access via the Web browser).

Furthermore, real-world attack payloads are increasingly crafted to hide themselves from detection by detector programs, which programs are designed to enumerate and examine the properties of many types of objects, including: the files present on the file system, keys or values present in a system registry, the processes running on the system, a set of threads currently running on the system, the DLLs or other modules loaded into a particular process, a list of those programs registered as “services” in the operating system, the session objects within a particular service application (such as an SQL server), or entries in other tables or lists or memory areas in the operating system, or in a particular part thereof, or in an applications object within a particular application program. The means to accomplish hiding are varied. One broad class of means-for-hiding is to subvert, modify, or hook the system calls or other functions that a detector program would use to enumerate various OS objects so that the detector program can examine them. The shell code in the attack payload then “filters out” or edits from the list the presence of objects that are part of the payload before the list is delivered to the detector program. It is often critical to successful hiding that the data (after filtering) should appear to be reasonable and normal to the detector program. A common means of meeting this requirement is to remove objects (or alter the reported property values) only for the objects that are part of the attack payload.

Examples of attacks that hide themselves from such detection are well-known, such as now described. A common attack is illustrated in FIG. 1. Here, a detector program 100 is provided and is intended to examine all the processes running on the operating system. In this example, the detector program 100 calls an operating system function 102 to obtain a list of the process identifiers (process ids) for all the processes on the system. In response, the operating system invokes system code 104 to create a list of all the process objects on the system. The list that is constructed is shown as reference numeral 106. The attacker's shell code 107, which has been injected as part of an attack payload, however, removes a process id for a process that is part of that payload; in this example, this is the value 1560. The edited list is illustrated at 108. When the detector program 100 does its examination using the edited list 108, it does not determine that the process is being hidden.

FIG. 2 illustrates another known attack in the context of an application process or service process. In this example, the process 200 in question has been exploited by the injection of additional code in a hidden DLL module 202. This is a known technique for hiding part of an attack payload from various detector programs. The reference numeral 204 illustrates the list of modules loaded from files into the process, which is obtained by a (low-level) debugging or other system code or call 203 that checks the internal state of the process. The reference numeral 206 identifies a portion of a high-level enumeration of all the module files that are present on the file system. (For convenience, the partial list is shown sorted lexicographically). The highlighted line 208 illustrates an instance of a hidden DLL. In this case, the attack tricked the operating system into loading a module as if it came from a file, even though there was no such actual file on the system. Thus, the module code would be hidden from an AV scanner or similar detector program, which scans or examines the actual files.

Many, if not most, known detector programs (e.g., anti-virus or “AV” scanners) have detected the presence of payloads by enumerating the objects of a certain type and comparing the individual objects with external information, e.g., a cryptographic or checksum signature based on what a particular authorized file “should be,” a cryptographic or checksum signature of a known “should not be” object (such as a Trojan executable file, or a Registry datum), a signature or expression pattern that matches specific communications from known network attacks, a list of what sets of processes “should be” or “should not be” running, or allowed to run, a list of what DLL or control modules “should be” possibly loaded in a particular process, or one or more rules or policies defining specific constraints on what files, registry datums, service requests or other information “should be” or “should not be” found and/or permitted.

In particular, one well-known existing method relies on detecting an inconsistency in “static” data, namely, between a static data object and a separate static and known reference copy of the data object. An example of this is a comparison of a separate and predefined checksum for the data in a known static system component (such as a DLL file used in the operating system or in a particular application) with a checksum data value calculated for the actual file at a later time. A change in the file most likely results in a different value, thus indicating that the file has been changed. This may indicate that the system has been compromised in a fashion that involved a persistent change to the file on the system. Such techniques typically involve a periodic scan of what may be a large number of objects to examine each file. Such scans may be costly in execution time; they are not “real-time.” A similar method involves comparison of the complete data contents of each object with the complete data contents of a static reference copy of each object. Yet another similar approach is to construct an independent static view of the contents of an object or a set of objects by means of special software (distinct from the system software) and then comparing this independently-constructed view with a view produced by the system software. To the extent that the two separate software components are in fact independent and construct views identical or equivalent from the same set of inputs, any inconsistency between the two views could be taken as an indication that the system has been compromised in a fashion intended to hide certain files or data from enumeration or examination (e.g., by other software). For example, this attack/compromise might be done to prevent malicious software files from being examined by other security software that scans and reviews all files on a file system to check for known virus or malware files. While such techniques do provide certain advantages, they involve expensive computation that may require systems to be taken off-line. Moreover, they only compare or examine properties of static objects or objects that have such long persistence that they can be considered static. Further, there may be a substantial development effort in reverse-engineering and other development work to develop the special software.

In addition, there are emerging numbers of detector programs that work by learning the “normal behavior” of a system, for example, by means of a behavioral, statistical or Markov model. These solutions do not provide strong evidence of attack per se, but instead provide a softer indication of “new behavior” by a program or system. These detectors must be trained with data from nominally normal operation so that they can build a statistical or other model of what program behavior is expected; thus, all other behavior is considered “new” and potentially suspect. While such techniques provide advantages, in many or perhaps most cases a newly-discovered behavior may be unrelated to an attack, thus resulting in a “false positive” detection. A further limitation of these types of systems is that they may be trained inadvertently to the behavior of a system that has already been compromised, resulting in “false negative” results. A further limitation of many such behavioral and similar models is that they may fail to recognize new behavior as sufficiently different to produce a detection, also resulting in “false negative” results.

Thus, although the prior art has many advantages, many of the above-described techniques suffer from several limitations including: dealing with known attacks only, failure in the presence of updates, inability to deal with an attack that can hide itself, implementation and/or management complexity, restriction to analysis of static objects, and lack of real-time performance. In addition, many of these techniques provide only non-enumerable measurements or data correlations that provide at best a weak set of forensic data for identifying the nature of the system attack.

### BRIEF SUMMARY OF THE INVENTION

The present invention detects that an information system has been compromised by a rootkit, worm, virus, trojan horse, or other attack payload. Generally, this is accomplished by detecting internal inconsistencies in system properties that are the result of the steps the attack payload takes to hide itself from other detector programs (such as a rootkit detector scanner or anti-virus scanner). The inventive technique detects many such attack payloads that would otherwise remain undetected or hidden, and the present invention makes it substantially more difficult for developers of other attack payloads to make their payloads hide themselves successfully from detection.

In general, the present invention describes a class of techniques for discovering evidence that a system (e.g., a computer system) has been compromised or attacked successfully. In an illustrative embodiment, a method involves detecting discrepancies between what properties a (compromised) operating system may report about certain enumerable system objects, and the actual properties of specific instances of those objects, found by other (instrumentation) software running on the same system. Preferably, the discrepancies are detected in real-time. Such discrepancies are strong indications of an effort to hide an attack from detection: thus, they are direct indications of an attack that could otherwise be hidden and not detected.

The inventive techniques can be applied both to operating system objects and to objects within applications. One exemplary implementation detects a broad class of attack payloads (such as DLLs) that are hidden from detection by other means. In this case, the discrepancy can be detected between the specific DLL files that the system reports as loaded into a process and the whether each such reported file is visible in an enumeration of what files are truly present on the file system.

A representative method begins by instrumenting one or more function(s) or operation(s) in the system at a given first level (e.g., at a low OS kernel level, but perhaps at another level) that either directly or implicitly provides an index, address, handle or other identifier of some particular system object. Using that identifier, a standard call, invocation, or query for enumerating all such objects, or examining one or more properties of the object, is then made at a given second level (e.g. at a higher user level, but perhaps at another level) in the system. This might be the same call that would be used by a detector application to get a list of such objects for examination. The method then determines whether the specific identifier is in the enumeration, or (if the property is checked) whether the property can be examined; if not, then this fact is a very strong indication that the system has been compromised. According to the method, it can be assumed that the returned list of objects, or the returned property, as the case may be, has been edited so that one or more objects involved in the compromise (e.g. an authorized process, or a fake DLL module) will not be examined by a detector application. In response to this determination, the method takes a given action such as a remediation, issuing an alert, or the like.

In a preferred embodiment, the inventive method is used to detect inconsistencies in “invariant” object properties, especially those object properties that are dynamic. As used herein, an “invariant” property of a system object is a property that always holds across a range of execution or execution states. Thus, an example of such an invariant property might be that a given thread (a system object) is always executed in a given context or in association with one and exactly one process (a different system object), and that every such process is always visible to the operating system. Another example might be that a module loaded into a process is always associated with one and exactly one file on the file system, and that that file is always visible to the operating system while the module is loaded. Another invariant property may be that a given program or module has a certain fixed relationship to another program or module. These are merely representative examples, of course. An object property may be invariant but the specific data value associated with that property may change over time; in this sense the property is also considered “dynamic.” The method as described above identifies system compromise or attack by recognizing or identifying inconsistencies between an invariant object property across a number of system levels.

Thus, an embodiment of the inventive method begins by instrumenting a function as described and then capturing or querying (in addition to the object identifier) a property (or several properties) of an object referenced by that functiontion. Preferably, these are one or more “invariant” properties. The method then preferably uses a separate system mechanism, such as a standard system API, to enumerate the properties of the object, preferably based on the reference or identifier for that object. A test is then performed to determine whether the properties differ; if so, this may be taken as an indication of compromise. According to the method, it can be assumed that the list of reported properties has been edited by shell code or an attack so as to disguise the true properties of an object involved in the compromise (e.g. an access privilege). A remedial action can then be taken in response.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 illustrates a prior art technique for hiding attack code from a detector system;

FIG. 2 illustrates another prior art technique for compromising a computer system;

FIG. 3 is a computer system in which the present invention may be implemented;

FIG. 4 illustrates an implementation of the present invention;

FIG. 5 illustrates another representative implementation of the inventive technique.

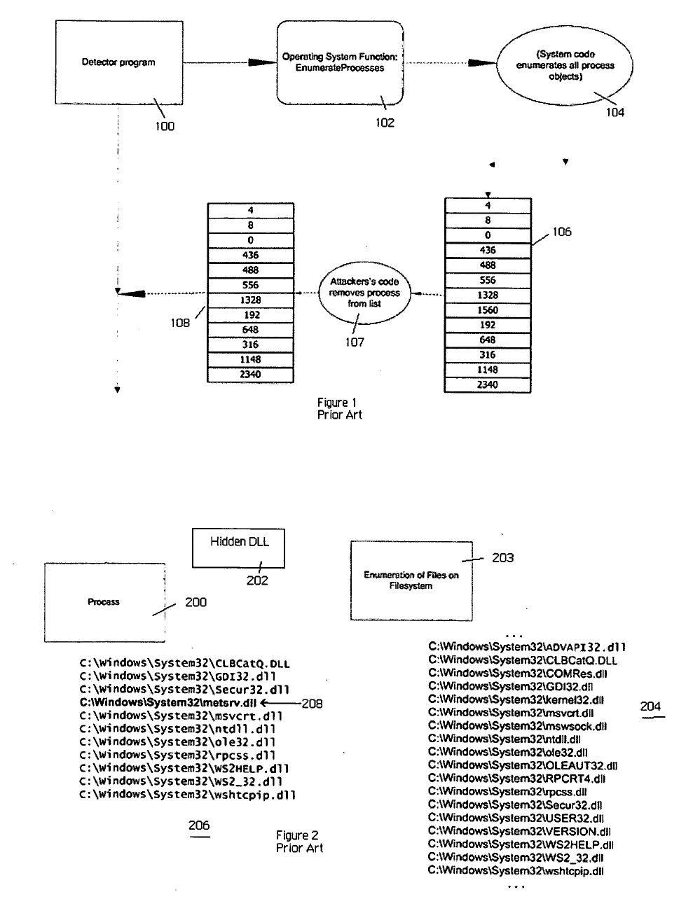

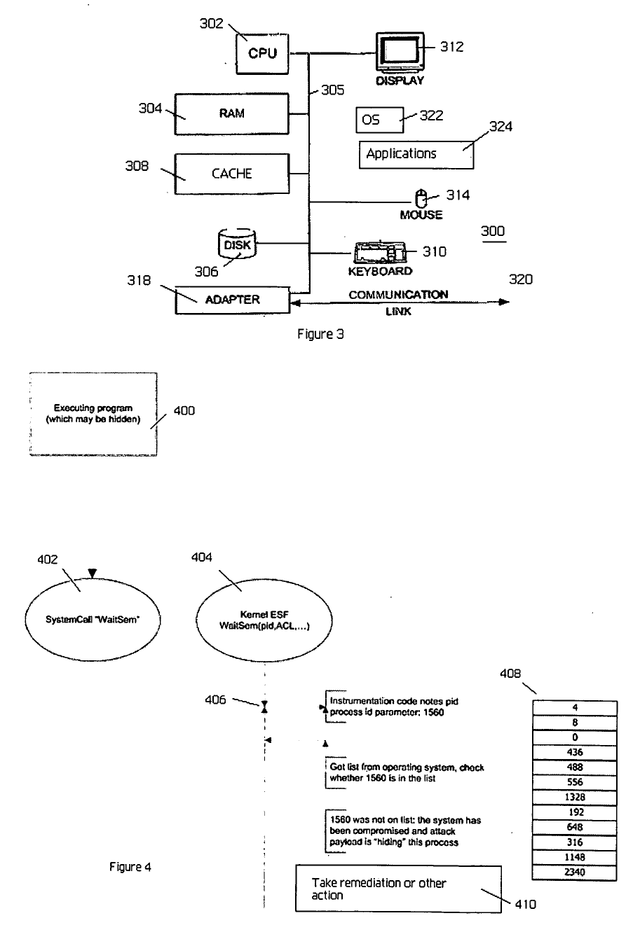

### DETAILED DESCRIPTION OF AN ILLUSTRATIVE EMBODIMENT

A computer or data processing system 300 in which the present invention may be implemented is illustrated in FIG. 3. This system is representative, and it should not be taken to limit the present invention. The system includes processor 302 coupled to memory elements through a system bus 305. The memory elements include local memory 304 employed during actual execution of the program code, disk storage 306, as well as cache memory 308 that provides temporary storage of program code and data. Input/output devices, such as a keyboard 310, a display 312, a pointing device 314, and the like, are coupled to the system either directly or through intervening I/O adapters or controllers (not shown). A network adapter 318 enables the system to become coupled to other systems or devices through intervening private or public networks 320. The system includes an operating system 322 and one or more application programs and utilities 324. Familiarity with basic operating system principles (including, without limitation, the concepts of operating system kernel space and user space) is presumed in the following discussion.

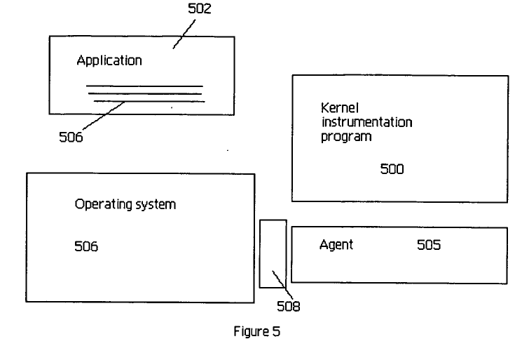

According to the invention, a method involves detecting discrepancies between what a (compromised) operating (or other) system may report about certain enumerable system objects, and specific instances of those objects found by other (instrumentation) software running on the same system. In one implementation, the discrepancies are detected in real-time. Such discrepancies are strong indications of an attack, or of an effort to hide an attack from detection: thus, they are direct indications of an attack that could otherwise be hidden and not detected. FIG. 4 illustrates this process.

It is assumed that program 400 is executing on the system. This program or process may be executing as a user-level process, or as an operating system kernel process. As illustrated, the program 400 has invoked a low-level function 402 within the operating system. In this example, which is merely representative, the function is “WaitSem,” which allows the calling program to wait for a semaphore object to change state. Reference numeral 404 illustrates the actual invocation of this low-level function, which includes (as an implicit parameter) the low-level process identifier (“pid”) of the calling program along with other information (such as an access right object “ACL”). According to the method, it is assumed that an instrumentation point 406 has been added to the system or is used within the operating system. At this instrumentation point, instrumentation code checks the process identifier value against a list of processes 408 obtained from an operating system call (such as described above with respect to FIG. 1). In this example, the value of the implicit pid parameter is 1560. According to the inventive method, the instrumentation code thus determines that a system call has been made from a process that is not in the list of processes reported by the operating system software. This inconsistency is a violation of an invariant dynamic property, namely, that the code of a calling program executes in the context of one and exactly one process, and that all processes are visible to via the operating system software. Thus, it is a clear indication that an attack payload is hiding this process from examination by detector programs. A remediation action 410 can then be taken.

Utilizing this technique, a system designer can readily design an implementation to kill the hidden process, suspend the hidden process, notify a person, entity or process, invoke other defensive software, shutdown certain network or other functions (to isolate the compromised system), or carry out some combination of these or other actions. As can be seen, the present invention need not provide the details of the attack payload; it is enough to know that an attack of some sort has been accomplished.

FIG. 5 illustrates another example of the present invention. In this example, a kernel instrumentation program (“KAI”) 500 monitors actions by application 502 and other programs by monitoring system calls to the operating system kernel, by registering callback functions for certain system operations, or by a combination of this and other instrumentation means. In one or more of instrumentation points 506, the KAI 500 obtains (e.g., directly from a lowest level of the operating system) the process and thread ids for the program performing or calling the instrumented operations. Periodically, or alternatively whenever the instrumentation sees an action indicative of a module being loaded by a program, the KAI 500 pauses/suspends the program and temporarily and passes control to a separate program (or “agent”) 505, preferably running at user level. Alternatively, the KAI does not pause the program 502 but instead provides data for possible detection by the agent 505. Thus, for example, in certain operations (e.g. CreateProcess), this value is provided directly by the operating system and no additional query is needed. The agent 505 then queries the operating system 506 (e.g., via a documented API 508) for a list (of file names) of modules loaded into that process. The agent checks the existence of modules against the enumeration of files on the file system. If any file from the list is not present in the enumeration, this is a strong indication of a “hidden DLL.”

It should be appreciated that the instrumentation or measurement of properties may be accomplished by any of a number of means without impacting the overall applicability of this method.

For example, in one embodiment of this invention, a number of properties are measured by means of a loadable instrumentation module that injects a small amount of crafted code by well-known means into certain key code paths of an operating system kernel such that a very low-cost measurement is made to a read a fundamental property, namely the pid under which the application or kernel code is executing (e.g., PsGetCurrentProcessID in the Windows OS.) As is well-known, an invariant property of the OS is that an application-level program with appropriate access privileges is able to get a process handle on any process on the system given the process ID. Thus, an embodiment of this invention includes an analysis module known as the “agent” that takes the process ID value determined by the instrumentation code and attempts to obtain a process handle (e.g., via the API OpenProcess(. . . )). Of course, both the PsGetCurrentProcessID operation and the OpenProcess operation are low-cost operations in the Microsoft Windows operating system. In this embodiment, the process ID (or other data) is conveyed from the instrumentation code to the analysis code by means of a telemetry stream or other suitable means. A failure of the OpenProcess operation (e.g., a failure with a status value that no such process ID exists) is a violation of the invariant property described above. This provides a low-cost and effective means of accomplishing immediate detection in real-time of a broad variety of “hidden process” compromises.

Note that the detection of compromise relies only on the invariant properties, in part, that for every process ID in the fundamental execution of software, it is possible to open a handle to the process. The embodiment includes other similar detections of violations of invariant properties, such as the invariant properties relating to thread IDs and obtaining a handle to a thread, the DLL or other file for a code module loaded into a process and obtaining a handle to that file on the operating system, the identifier of a port or socket and accessing information about that port or socket. Additional invariant properties include the accessibility of a process ID or other fundamental dynamic property to other OS APIs, such as the Tool Help APIs, the process ID under which a thread executes, and any of a number of APIs which access files or directories in the file system. These are merely representative.

Once it has been detected that an attack has been made, one or more remediation actions can be taken. Remediation actions are well known and familiar in the current art. Examples of remediation actions would include terminating a process for which some invariant condition is violated, denying continued operation with or use of data returned or obtained by an operation in which an invariant condition is violated, immediately invoking a separate (and more costly) analysis by means of an automated audit or scan of the system, reporting a notification to an existing IDS Intrusion Detection System or NIDS Network Intrusion Detection System, or making use of a firewall or router to other network control device to isolate the system which has been compromised from other systems on a network as a means for confining the compromise to only those systems already compromised.

Concerning the means of instrumentation, in one embodiment the present invention uses a loadable instrumentation module to produce a telemetry stream of certain property values. One reference to such a loadable instrumentation embodiment is U.S. Patent Application 20060190218, by Agarwal et al. Other embodiments would include such means as filter drivers for obtaining a telemetry stream for file and/or network operation, or hardware monitors or combinations of hardware/software monitors for reading properties of sub-systems or devices within the system. In addition, the means for reading dynamic properties, and/or the means for analyzing the properties for violations of invariant conditions, could be implemented directly in the operating system or system itself. This last embodiment would have obvious advantages, in that additional instrumentation or access to properties could be designed into the system for the specific purpose of extending the set of invariant properties which would be examined. A further advantage would be that the methods of this invention could be used in cases where other aspects of the system, such as security or access restrictions to prevent the use of third-party or add-in software, would make implementation of loadable instrumentation software difficult.

As a matter of engineering judgment and trade-off, the overall cost or overhead of certain analysis and/or instrumentation could be reduced by judicious “sampling” of certain invariant properties, in which a trade-off between some amount of overhead, and the timeliness of immediate detection of compromise, is made. For example, a check for inconsistencies in the process ID check mentioned above could be made only on every tenth datum, which would reduce the overall overhead of making this check, but due to the low cost and relatively frequent checking of this invariant property, might still result in very immediate detection of a compromise.

If desired, the above-described embodiment may be integrated with existing models for monitoring program behavior, such as statistical, Markov, and/or other behavioral models of system call activity. As noted above, such models also provide general (albeit “softer”) indications of a possible attack. As part of that integration, the invariant checks are able to detect the presence of certain attacks in the training data that would otherwise be used to train the behavior models; in such case, this prevents the behaviors from the attack from being incorporated in the behavioral model.

The present invention has numerous advantages over the prior art. The inventive method preferably is based on dynamic properties and thus can be used to detect compromises that may leave static properties, or the data contents of static objects, unchanged. Thus, as compared to the prior art, the method can detect a wider range of system compromises. Moreover, as noted above, the method preferably is based on invariant properties of objects and not on specific data values or object contents. Thus, the method is able to detect a wider variety of compromises, including those that may exhibit polymorphism or changes in their specific data contents either by their nature or as an intentional measure to make detection difficult. The present invention need not rely on specific data values, such as checksums or signatures. Further, because the inventive method preferably is based on invariant object properties (as opposed to detection of specific signatures or object data values), it can detect novel compromises (or “zero day” attacks) that have not been previously diagnosed or detected, or that may otherwise go undetected.

The inventive method also is advantageous in that may be practiced with any invariant property. One of ordinary skill in the art will appreciate that the specific properties of course depend on the design of the system being protected. A set of appropriate properties may be selected as a matter of design choice, depending on the particular system. Such properties may also be derived by automatic code or architectural analysis. Further, although the inventive method has been described in the content of invariant property analysis, this is not a limitation, as the described techniques can also be used with properties that, while not completely invariant, have a high probability of being substantially invariant. Also, the techniques may be used with a set of substantially invariant properties that together produce a combined or aggregate property that itself can be considered invariant.

By making use of invariant properties (or properties that can be treated as invariant or substantially-invariant), the present invention does not rely on behavioral analysis or modeling system behavior.

There are many advantages provided by the present invention. The techniques require little or no training because they can deal with fundamental invariant properties of the system or application and its objects. In addition, the techniques are in many aspects relatively simple compared to the complexity of many other means, and thus are likely to have fewer errors in implementation. As compared to the prior art, the techniques require less custom code or reverse engineering. In particular, in most cases the information used in the correlations is obtained directly from the operating system; thus, there is no need to reverse engineer operating system structures or functionalities (e.g. duplicate the functionality of the file system code to create an independent view from reading the “raw” disk data). The techniques are simple to manage because there are fewer aspects that could be considered as rules or policies that must be configured. Moreover, the techniques may be implemented so as to execute in real-time without placing a significant performance burden on the system or application. Further, the techniques are difficult to bypass because the correlation preferably deals with fundamental “invariants” of the sets of operating system or application objects. Thus, the techniques are harder for an attack to manipulate or bypass without causing an outright failure of the system (with the benefit that this failure itself betrays the existence of an attack). Bypassing the detection would require that the attack make more pervasive, more complex, and more difficult changes to the operating system or application, in order to hide itself.

Another advantage over the prior art is that the correlation is not specific to any particular attack means, but instead detects any attack that causes a visible inconsistency in the system objects. Thus, as compared to the prior art, the present invention need not be as specific to the particular means of manipulation that an attack uses to alter how these enumerations or properties are reported. Another advantage is ease of integration with behavioral and other forms of analysis. As noted above, the techniques provide strong indicators of attack behavior. As indicators of attack behavior, they can be integrated with more general models of behavior that provide softer indications of possible attack. Especially when the models use much of the same instrumentation, and the management of the detector implementation is also much the same, the cost of the detector system remains low, and the likelihood of detecting attack is improved overall.

The invention may be implemented in any computer environment, but the principles are not limited to protection of computer systems. In a representative implementation, the invention is implemented in a set of one or more computing-related entities (systems, machines, processes, programs, libraries, functions, or the like) that facilitate or provide the described functionality. A representative machine on which a component of the invention executes is a client workstation or a network-based server running commodity (e.g., Pentium-class) hardware, an operating system (e.g., Windows XP, Linux, OS-X, or the like), optionally an application runtime environment, and a set of applications or processes (e.g., native code, linkable libraries, execution threads, applets, servlets, or the like, depending on platform) that provide the functionality of a given system or subsystem. The method may be implemented as a standalone product, or as a managed service offering, or as an integral part of the system. As noted above, the method may be implemented at a single site, or across a set of locations in the system. Of course, any other hardware, software, systems, devices and the like may be used. More generally, the present invention may be implemented in or with any collection of one or more autonomous computers (together with their associated software, systems, protocols and techniques) linked by a network or networks. All such systems, methods and techniques are within the scope of the present invention.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the present invention has been described in the context of a method or process, the present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus. A given implementation of the present invention is software written in a given programming language that runs on a standard hardware platform running an operating system.

While given components of the system have been described separately, one of ordinary skill will appreciate that some of the functions may be combined or shared in given instructions, program sequences, code portions, and the like.

Having described my invention, what I now claim is as follows.

1. A method of protecting a system, comprising:
detecting a given behavior by comparing information obtained directly from an information object with information the computer system provides or can provide about the information object; and
taking a given action to protect the system in response to the detecting step.

2. The method as described in claim 1 wherein the given action replaces a component that has been compromised with a known good copy of the component.

3. The method as described in claim 1 wherein the given action isolates the computer system to prevent spread of the compromise to other systems.

4. The method as described in claim 1 wherein the given action restricts access to the component that has been compromised.

5. The method as described in claim 1 wherein the given action isolates the component that has been compromised.

6. The method as described in claim 1 wherein the information object is one of an operating system object, and an application object.

7. The method as described in claim 1 wherein the information obtained from the information object includes at least one property.

8. The method as described in claim 7 wherein the property is invariant.

9. A method of protecting a computer system, comprising:
for a given information object in the computer system, comparing information about an execution state with at least one invariant property of the given information object; and
taking a remediation action as a result of the comparing step.

10. The method as described in claim 9 wherein the remediation action is one of: replacing a component that has been compromised with a known good copy of the component, isolating the computer system to prevent spread of the compromise to other systems, restricting access to the component that has been compromised, issuing a given notification, performing further detection or analysis, and isolating the component that has been compromised.

11. A method of protecting a system, comprising:
for a given information object in the system, wherein the given information object belongs to a set of information objects, comparing a direct observation that the information object exists in the computer system with information provided by the computer system about the set of information objects; and
taking a remediation action as a result of the comparing step.

12. The method as described in claim 11 wherein the remediation action is one of: replacing a component that has been compromised with a known good copy of the component, isolating the system to prevent spread of the compromise to other systems, restricting access to the component that has been compromised, issuing a given notification, performing further detection or analysis, and isolating the component that has been compromised.

13. The method as described in claim 1 wherein the behavior is a dynamic behavior and the information object is a dynamic information object.

14. The method as described in claim 1 wherein the information obtained directly from an information object is obtained in a first level of the system and the information the system provides or can provide about the information object is obtained from a second level of the system that differs from the first level.

15. The method as described in claim 14 wherein the first level is a level associated with a user space and the second level is associated with an operating system kernel.
